(19) United States
(12) Patent Application Publication
(10) Pub. No.: US 2016/0253828 A1
(43) Pub. Date: Sep. 1, 2016

(54) DISPLAY CONTROL SYSTEM, AND GRAPH DISPLAY METHOD

(71) Applicant: FUJITSU LIMITED, Kawasaki-shi (JP)

(72) Inventors: Takehiko NISHIMURA, Kawasaki (JP); Kazuki TAKAHASHI, Wako (JP); Ryota SAKAGUCHI, Itabashi (JP)

(73) Assignee: FUJITSU LIMITED, Kawasaki-shi (JP)

(21) Appl. No.: 14/993,138

(22) Filed: Jan. 12, 2016

(30) Foreign Application Priority Data
Feb. 27, 2015 (JP) 2015-039507

(51) Int. Cl. G06T 11/20; G06T 15/60; G06T 11/40

(52) U.S. Cl. CPC G06T 11/206; G06T 11/40; G06T 15/60; G06T 2215/12

(57) ABSTRACT

A display control system includes: a display control device including a memory; and a processor coupled to the memory, wherein the processor executes a process including: displaying, when displaying a plurality of graphs in a layered manner by performing translucent display, a layered structure of the graphs that represents an order of stacking of the graphs in a vertical direction and a width of each of the graphs in a horizontal direction.

### CROSS-REFERENCE TO RELATED APPLICATION

This application is based upon and claims the benefit of priority of the prior Japanese Patent Application No. 2015-039507, filed on Feb. 27, 2015, the entire contents of which are incorporated herein by reference.

### FIELD

The embodiment discussed herein is directed to a display control system, a graph display method, and a computer-readable recording medium.

### BACKGROUND

Data involved in corporate activities is accumulated and used. For example, data, such as operation logs of manufacturing equipment in a product assembly line is accumulated and used for improving the production process. A development tool has been developed to facilitate development of software for displaying an operation panel of an information communication device or a home electric appliance. The development tool has been developed to display mutually overlapping images each having positional information on a display surface, to obtain coordinates based on an operation on the display surface by a user, and to display identifiers of all the overlapping images each having the positional information including the coordinates, as options in a list.

In addition, an editing method has been developed in which, when a compound document composed of a plurality of data areas, such as text data, graphs, and graphic symbols, is edited, the layered structure of the data areas can be displayed in a patterned manner in any cross section of the compound document, and a data area in any layer can be selected as a target of an editing operation. Conventional techniques are described, for example, in Japanese Laid-open Patent Publication No. 10-340177 and Japanese Laid-open Patent Publication No. 08-161519.

However, in some cases, if the images are displayed in a mutually overlapping manner on the display surface, it is difficult to identify which of the images is the operation target. This causes the user to select an image different from an image that the user wants to operate, in some cases. For example, in some cases, the user takes time to select information indicating an abnormality in manufacturing equipment as an operation target.

### SUMMARY

According to an aspect of an embodiment, a display control system includes: a display control device including a memory; and a processor coupled to the memory, wherein the processor executes a process including: displaying, when displaying a plurality of graphs in a layered manner by performing translucent display, a layered structure of the graphs that represents an order of stacking of the graphs in a vertical direction and a width of each of the graphs in a horizontal direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a display control system according to an embodiment of the present invention;

FIG. 2 is a diagram illustrating example data stored in a log storage unit;

FIG. 3 is a diagram illustrating example data stored in a transmittance storage unit;

FIG. 4 is a diagram illustrating the example data stored in the transmittance storage unit;

FIG. 5 is a diagram illustrating the example data stored in the transmittance storage unit;

FIG. 6 is a diagram illustrating an example of a display screen;

FIG. 7 is a diagram illustrating another example of the display screen;

FIG. 8 is a diagram illustrating still another example of the display screen;

FIG. 9 is a diagram illustrating an example schematically representing graphs and a layered structure of the graphs;

FIG. 10 is a diagram illustrating another example schematically representing the graphs and the layered structure of the graphs;

FIG. 11 is a diagram illustrating still another example schematically representing the graphs and the layered structure of the graphs;

FIG. 12 is a diagram illustrating an example of movement of the graphs between layers;

FIGS. 13A and 13B are diagrams illustrating a method for the movement of the graphs between layers;

FIGS. 14A and 14B are diagrams illustrating methods for deleting and hiding a graph using the layered structure;

FIG. 15 is a flowchart illustrating an example of a transmittance control process of the embodiment;

FIG. 16 is a flowchart illustrating an example of a first transmission process;

FIG. 17 is a flowchart illustrating an example of a second transmission process;

FIG. 18 is a flowchart illustrating an example of a third transmission process;

FIG. 19 is a flowchart illustrating an example of a layered structure display process of the embodiment; and

FIG. 20 is a diagram illustrating an example of a computer for executing a graph display program.

### DESCRIPTION OF EMBODIMENT

Preferred embodiments of the present invention will be explained with reference to accompanying drawings. The embodiment does not limit the technique disclosed herein. The embodiment below may be combined with other embodiments as appropriate unless any contradiction occurs.

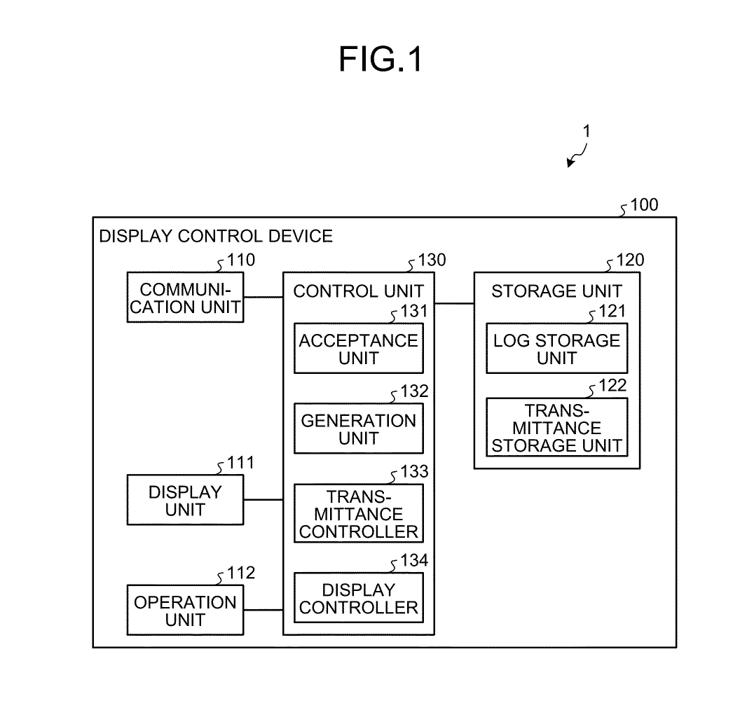

FIG. 1 is a block diagram illustrating an example of a configuration of a display control system according to the embodiment. This display control system 1 illustrated in FIG. 1 includes a display control device 100. The display control system 1 may include, for example, a control device for a machine tool and various types of test equipment, such as temperature test equipment, in addition to the display control device 100. The display control device 100 can acquire log data from various devices. The display control system 1 may also include a terminal device for an administrator. The display control device 100 is connected to the various devices so as to be communicable with each other through a network (not illustrated). The following description will be made by exemplifying a case in which various types of information on the product assembly line are acquired as the log data.

The display control device 100 of the display control system 1 illustrated in FIG. 1 generates graphs displaying the log data acquired from the various devices in a superimposed manner, and provides the graphs to the administrator of the product assembly line. The display control device 100 displays a plurality of types of the log data as respective objects, that is, respective display components in a superimposed manner in accordance with a predetermined time axis. In some cases, the display control device 100 displays a first display component and a second display component in an at least partially overlapping manner. In such cases, the display control device 100 performs control to increase the transmittance in the overlapping portion according to the density of display contents included in the first display component or the density of display contents included in the second display component in the overlapping portion. In other words, the display control device 100 displays the graphs in a layered manner by performing translucent display. The display contents are data plotted on the graphs, and are, for example, quantitative data, such as temperature and humidity, and log data, including event data such as error messages. The transmittance in the overlapping portion is controlled such that at least either of the first and second display components is increased in transmittance.

The display control device 100 also displays a layered structure of the graphs that represents the order of stacking of the layered graphs in the vertical direction and the width of each of the graphs in the horizontal direction, in other words, displays a cross section of the layered graphs. In this manner, the display control device 100 can perform display that makes it easy to understand which graph object is an operation target. The graph object refers to each of the graphs, and will be also expressed as a graph in the description below.

The following describes the configuration of the display control device 100. As illustrated in FIG. 1, the display control device 100 includes a communication unit 110, a display unit 111, an operation unit 112, a storage unit 120, and a control unit 130. The display control device 100 may include various functional units included in a known computer, including functional units such as various input devices and audio output devices, in addition to the functional units illustrated in FIG. 1.

The communication unit 110 is implemented, for example, by a network interface card (NIC). The communication unit 110 is a communication interface that is connected, in a wired or wireless manner, to the various devices so as to be communicable with each other through the network (not illustrated), and that serves for information communication with the various devices. The communication unit 110 receives the log data from the various devices. The communication unit 110 outputs the received log data to the control unit 130.

The display unit 111 is a display device for displaying the various types of information. The display unit 111 is implemented, for example, by a liquid crystal display as a display device. The display unit 111 displays various screens, such as a display screen supplied from the control unit 130.

The operation unit 112 is an input device for accepting various operations from the administrator. The operation unit 112 is implemented, for example, by a keyboard and a mouse as input devices. The operation unit 112 outputs the operations entered by the administrator, as operational information, to the control unit 130. The operation unit 112 may be implemented, for example, by a touchscreen as an input device, and the display device of the display unit 111 may be integrated with the input device of the operation unit 112.

The storage unit 120 is implemented, for example, by semiconductor memory devices such as a random access memory (RAM) and a flash memory, and storage devices, such as a hard disk and an optical disc. The storage unit 120 includes a log storage unit 121 and a transmittance storage unit 122. The storage unit 120 stores therein information used for processing by the control unit 130.

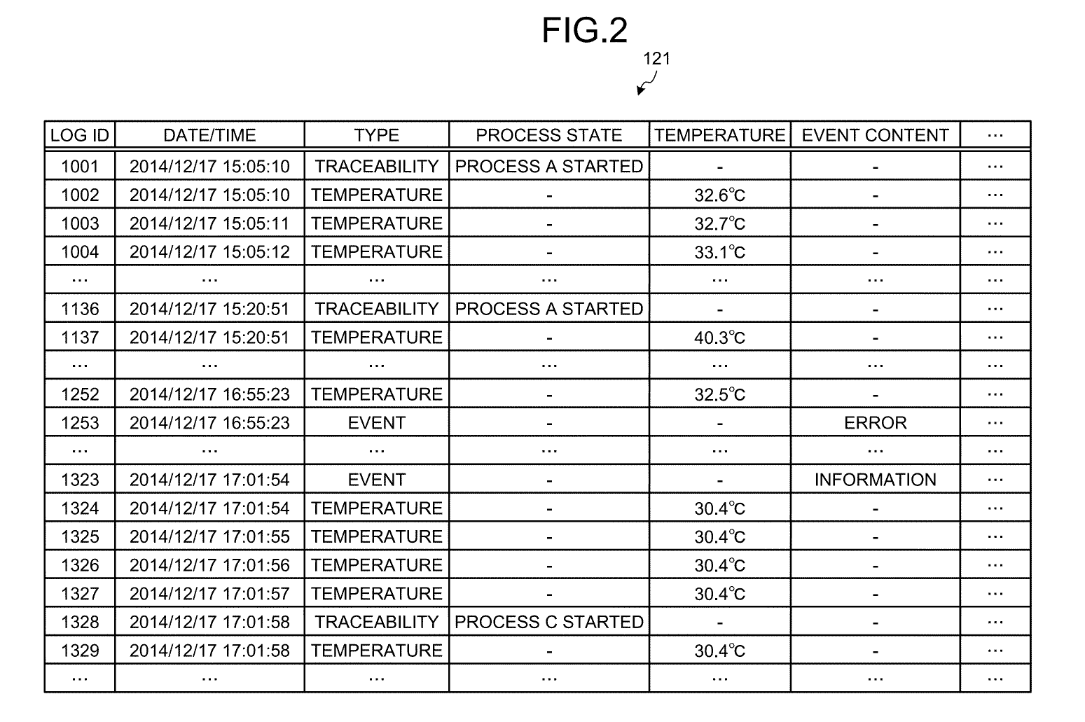

The log storage unit 121 stores therein the log data received from the various devices. FIG. 2 is a diagram illustrating example data stored in the log storage unit. As illustrated in FIG. 2, the log storage unit 121 contains items, such as “log ID”, “date/time”, “type”, “process state”, “temperature”, and “event content”. The log storage unit 121 stores therein, for example, each element of the log data as one record.

The item “log ID” represents an identifier for identifying each element of the log data. The item “date/time” represents information indicating the date and time when each element of the log data was obtained. The item “type” represents information indicating the type of the log data. Examples of the type include, but are not limited to, “traceability” indicating the start or the end of a process, “temperature” indicating the temperature of a certain place in the assembly line, and “event” indicating occurrence of, for example, an error. The item “process state” represents information indicating the start or the end of each process, if the type is “traceability”. The item “temperature” represents the temperature, if the type is “temperature”. The item “event content” represents information indicating the content of an event, if the type is “event”. Examples of the event content include, but are not limited to, “emergency”, “error”, and “information”. The event content “emergency” is issued, for example, when manufacturing equipment fails and stops operating. The event content “error” is issued, for example, when a component of a product to be manufactured by the manufacturing equipment is not supplied, so that the product will not be assembled. The event content “information” is issued, for example, when the quantity of components of a product to be manufactured by the manufacturing equipment reaches a certain value or smaller. Pieces of the log data that are different in “type” may be obtained at the same date and time. For example, there may be a case where the type of a piece of the log data with a log ID of “1252” is “temperature” whereas the type of another piece of the log data with a log ID of “1253” is “event”, and the date/time of both pieces of the log data is “2014/12/17 16:55:23”.

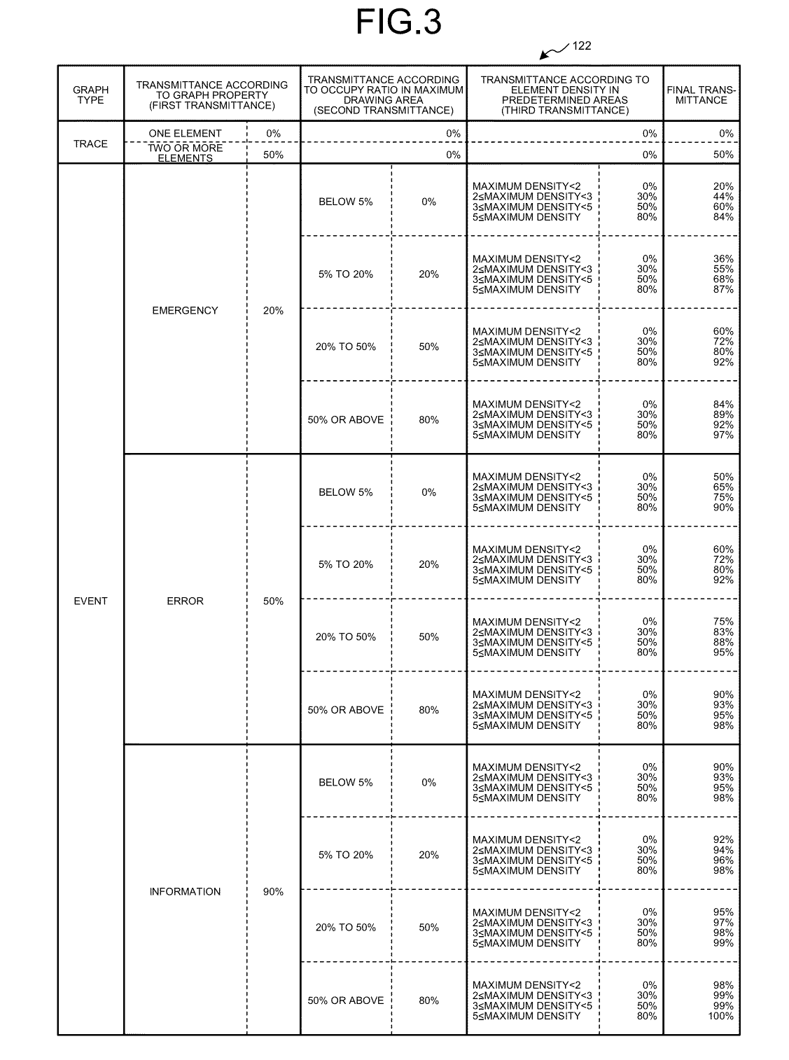

Coming back to the description with reference to FIG. 1, the transmittance storage unit 122 stores therein a final transmittance based on conditions, such as the type and property of a graph, the size of the graph occupied in a drawing area, and the density of elements of the graph, in a manner associated with the conditions. FIGS. 3 to 5 are diagrams illustrating example data stored in the transmittance storage unit. As illustrated in FIGS. 3 to 5, the transmittance storage unit 122 contains items, such as “graph type”, “transmittance according to graph property”, “transmittance according to occupy ratio in maximum drawing area”, “transmittance according to element density in predetermined areas”, and “final transmittance”.

The item “graph type” represents information indicating the type of the displayed graph. The graph type is set to, for example, “trace” when the log data is traceability data, “heat map” when the log data is quantitative data, or “event” when the log data is event data. The item “transmittance according to graph property” represents information indicating the transmittance according to the graph property of each graph type. In the description below, the transmittance according to the graph property will be expressed as first transmittance. If, for example, the graph type is “trace”, the first transmittance is set as follows: the transmittance is set to 0% if only one element is present at a certain time, or set to 50% if two or more elements overlap one another at that time.

If, for example, the graph type is “heat map”, and values in upper and lower ranges of a normal distribution are to be viewed, percentiles are used to set the first transmittance. In that case, for example, the first transmittance can be set to a transmittance of 0% if x<X_{2.5}, to a transmittance of 50% if X₂₀₅<x<X₁₅, to a transmittance of 90% if X₁₅<x<X₈₅, to a transmittance of 50% if X₈₅<x<X_{97.5}, or to a transmittance of 0% if x>X_{97.5}, where x represents, for example, the temperature. If, for example, the graph type is “event”, the first transmittance can be set to a transmittance of 20% if the event content is “emergency”, to a transmittance of 50% if the event content is “error”, or to a transmittance of 90% if the event content is “information”.

The item “transmittance according to occupy ratio in maximum drawing area” represents information indicating the transmittance according to the ratio of a drawing area in which the element is drawn to the maximum drawing area. In the description below, the transmittance according to the occupy ratio in the maximum drawing area will be expressed as second transmittance. For example, the second transmittance can be set to a transmittance of 0% if the ratio becomes lower than 5%, to a transmittance of 20% if the ratio is 5% or higher and lower than 20%, to a transmittance of 50% if the ratio is 20% or higher and lower than 50%, or to a transmittance of 80% if the ratio is 50% or higher. If, for example, the graph type is “heat map”, the second transmittance is set according to a ratio occupied by the width of the heat map. The ratio occupied by the width of the heat map represents a ratio of the width of the heat map to the width of the entire graph (display area), or to the width of one of divided areas obtained by dividing the graph into a plurality of divisions. The width of the entire graph or the width of one of the divided areas obtained by dividing the graph into a plurality of divisions corresponds to the width of the maximum drawing area in which data of the heat map can be drawn.

If, for example, the graph type is “event”, the second transmittance represents transmittance according to a ratio of the diameter of a point having the largest diameter among displayed points (elements of data) to the length of the time axis of the graph. The length of the time axis of the graph may be the length of the time axis of the graph displayed in a display area displayable at the same time, or may be the length of the time axis of one of the divided areas obtained by dividing the graph into a plurality of divisions. In other words, the length of the time axis of the graph corresponds to the width of the maximum drawing area in which data of the event graph can be drawn.

For example, the point of the event graph can have a diameter of 20 pixels if the event content is “emergency”, a diameter of 10 pixels if the event content is “error”, or a diameter of 4 pixels if the event content is “information”. In this case, if, for example, the number of pixels in the vertical direction of the display area is 200 and points corresponding to “emergency” are plotted in the display area, the ratio of the diameter of the point having the largest diameter to the length of the time axis of the display area is obtained as 20/200=10%. As a result, the second transmittance can be set to 20%.

The item “transmittance according to element density in predetermined areas” represents information indicating the transmittance according to, for example, the maximum density in a plurality of predetermined areas among densities each calculated for corresponding one of the predetermined areas by multiplying the number of elements of the data, such as the data of the heat map and the data of the event graph, by a coefficient. For example, one of the divided areas obtained by dividing the graph into a plurality of divisions can be used as each the predetermined areas. In the description below, the transmittance according to the element density in the predetermined areas will be expressed as third transmittance. For example, the third transmittance can be set to a transmittance of 0% if the maximum density becomes lower than 2, to a transmittance of 30% if the maximum density is 2 or higher and lower than 3, to a transmittance of 50% if the maximum density is 3 or higher and lower than 5, or to a transmittance of 80% if the maximum density is 5 or higher.

The item “final transmittance” represents information indicating the transmittance applied to each of the graphs in the graph display area on the display screen displayed on the display unit 111. The final transmittance is calculated based on the first, second, and third transmittances.

Coming back to the description with reference to FIG. 1, the control unit 130 is implemented, for example, by executing programs stored in an internal storage device, using a central processing unit (CPU), a microprocessor unit (MPU), or the like, and using a RAM as a work area. The control unit 130 may be implemented, for example, by an integrated circuit, such as an application-specific integrated circuit (ASIC) or a field-programmable gate array (FPGA). The control unit 130 includes an acceptance unit 131, a generation unit 132, a transmittance controller 133, and a display controller 134, and implements or executes functions or operations to be described below. The internal configuration of the control unit 130 is not limited to the configuration illustrated in FIG. 1, but may be another configuration in which information processing to be described below is performed.

When the operational information to display the graphs has been received from the operation unit 112, the acceptance unit 131 accepts to display the graphs. After accepting to display the graphs, the acceptance unit 131 acquires the log data from the various devices via the communication unit 110. The acceptance unit 131 stores the acquired log data in the log storage unit 121. After completing to store the acquired log data, the acceptance unit 131 outputs generation information to the generation unit 132. The acceptance unit 131 may continuously store the log data acquired from the various devices, in real time. In this case, the acceptance unit 131 outputs the generation information to the generation unit 132 at the time of completing to store data enough to be displayed in the display area, in the log storage unit 121.

After receiving the generation information from the acceptance unit 131, the generation unit 132 generates the graphs to be displayed on the display screen, that is, the graphs to be displayed in the graph display area, with reference to the log storage unit 121. Specifically, the generation unit 132 performs a process of generating the graphs in a first transmission process including the process of generating the graphs and a process of generating the first transmittance. The generation unit 132 acquires data of the respective elements on a type-by-type basis of the data for generating the graphs, from the log storage unit 121. The generation unit 132 determines whether the acquired data is the traceability data. If so, the generation unit 132 generates a trace graph in which start times of respective processes are interconnected, end times of the respective processes are interconnected, and the results are expressed as data bands. If not, the generation unit 132 determines whether the acquired data is the quantitative data.

If so, the generation unit 132 generates a heat map in which each of the processes is expressed as a band parallel to the time axis. If not, the generation unit 132 determines that the acquired data is the event data, and generates an event graph in which an event occurring on the time axis in each of the processes is expressed as a circular point. The generation unit 132 may generate, for example, a line graph or a bar graph according to the type of the log data, in addition to the event graph. The generation unit 132 outputs the trace graph, the heat map, and the event graph thus generated, as graph data, to the transmittance controller 133.

After receiving the graph data from the generation unit 132, the transmittance controller 133 generates the first, second, and third transmittances, with reference to the transmittance storage unit 122. The transmittance controller 133 calculates the final transmittance based on the generated first, second, and third transmittances.

First, the following describes the process of generating the first transmittance in the first transmission process. If the graph data is that of a trace graph, the transmittance controller 133 determines whether parallel processing processes are included and also the data bands overlap one another. If so, the transmittance controller 133 generates the first transmittance to set the transmittance of the data bands to 50%. If no parallel processing processes are included or the data bands do not overlap one another, the transmittance controller 133 generates the first transmittance to set the transmittance of the data bands to 0%.

If the graph data is that of a heat map, the transmittance controller 133 generates the first transmittance that is set to a transmittance according to the distribution of the data, with reference to the transmittance storage unit 122. If the graph data is that of an event graph, the transmittance controller 133 generates the first transmittance that is set to a transmittance according to the type of the event, with reference to the transmittance storage unit 122. The transmittance controller 133 determines whether the generation of the graphs and the first transmittances has been completed for all the data types. If not, the transmittance controller 133 selects the next data type, and outputs a command for generating a graph to the generation unit 132. If the generation of the graphs and the first transmittances has been completed for all the data types, the transmittance controller 133 performs the process of generating the second transmittance.

The following describes a second transmission process of generating the second transmittance. The transmittance controller 133 determines whether the graph for which the first transmittance has been generated is in the backmost position in the display order. If so, the transmittance controller 133 generates the second transmittance so as not to change the setting of the transmittance, with reference to the transmittance storage unit 122. Specifically, the transmittance controller 133 generates the second transmittance that is set to a transmittance of 0%. If the graph is not in the backmost position in the display order, the transmittance controller 133 determines whether the graph is a heat map.

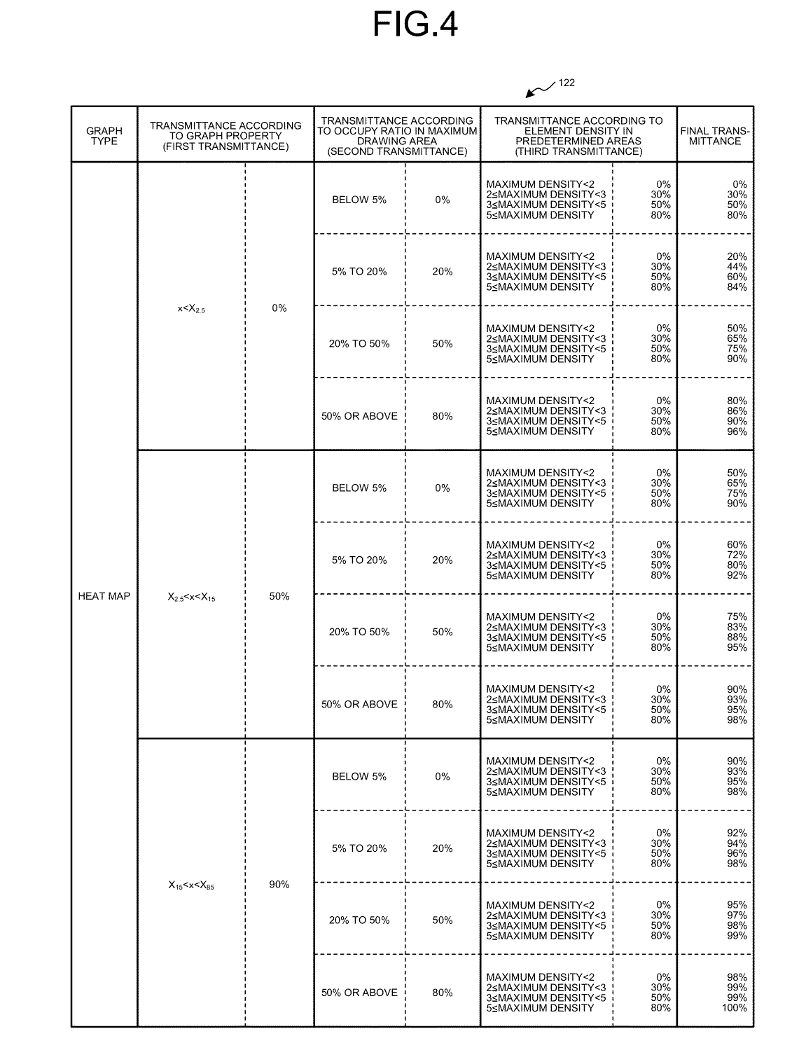

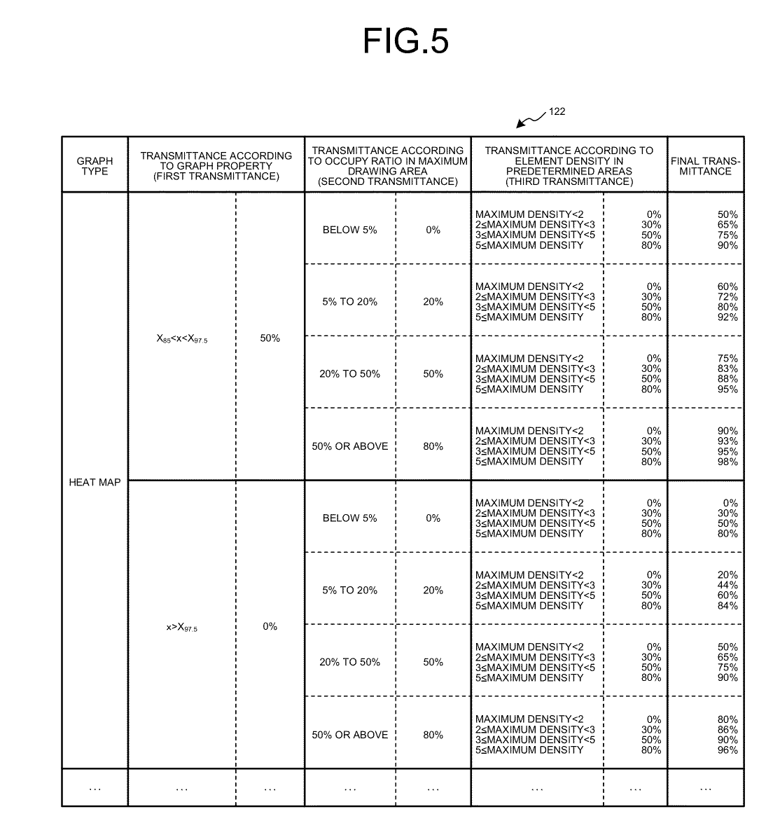

If so, the transmittance controller 133 generates the second transmittance that is set to a transmittance according to the ratio of the width of the heat map to the width of the entire graph, or to the width of each of the divided areas, with reference to the transmittance storage unit 122. In the example of FIGS. 4 and 5, the transmittance controller 133 generates the second transmittance that is set to a transmittance of 0% if the ratio of the width of the heat map to the width of the entire graph, or to the width of each of the divided areas, that is, to the width of the maximum drawing area, becomes lower than 5%, or is set to a transmittance of 20% if the ratio is 5% or higher and lower than 20%. The transmittance controller 133 generates the second transmittance that is set to a transmittance of 50% if the ratio of the width of the heat map to the width of the maximum drawing area is 20% or higher and lower than 50%, or to a transmittance of 80% if the ratio is 50% or higher.

If the graph is not a heat map, the transmittance controller 133 determines whether the graph is an event graph. If so, the transmittance controller 133 generates the second transmittance that is set to a transmittance according to the ratio of the diameter of a point having the largest diameter among points of the event graph to the length of the time axis of the graph, with reference to the transmittance storage unit 122. In the example of FIG. 3, the transmittance controller 133 generates the second transmittance that is set to a transmittance of 0% if the ratio of the diameter of the point having the largest diameter to the length of the time axis of the graph becomes lower than 5%, or is set to a transmittance of 20% if the ratio is 5% or higher and lower than 20%. The transmittance controller 133 generates the second transmittance that is set to a transmittance of 50% if the ratio of the diameter of the point having the largest diameter to the length of the time axis of the graph is 20% or higher and lower than 50%, or to a transmittance of 80% if the ratio is 50% or higher.

If the graph is not an event graph, the transmittance controller 133 generates the second transmittance so as not to change the setting of the transmittance, with reference to the transmittance storage unit 122. Specifically, the transmittance controller 133 generates the second transmittance that is set to a transmittance of 0%.

The following describes a third transmission process of setting a coefficient of density used for generating the third transmittance. The transmittance controller 133 determines whether the graph for which the second transmittance has been generated is in the backmost position in the display order. If so, the transmittance controller 133 generates the third transmittance so as not to change the setting of the transmittance, with reference to the transmittance storage unit 122. Specifically, the transmittance controller 133 generates the third transmittance that is set to a transmittance of 0%. If the graph is not in the backmost position in the display order, the transmittance controller 133 determines whether the graph is a heat map.

If so, the transmittance controller 133 sets the coefficient of density according to the ratio of the width of the heat map to the width of the entire graph, or to the width of each of the divided areas. If not, the transmittance controller 133 determines whether the graph is an event graph. If so, the transmittance controller 133 sets the coefficient of density, on a divided area-by-divided area basis, based on the number of points in the event graph and the ratio of the diameter of each of the points to the length of the time axis of the divided area. As for the divided area, a case is included where the display area is assumed as one divided area.

If the graph is not an event graph, the transmittance controller 133 sets the coefficient of density to a value set in advance according to the type of the graph. The coefficient of density can be set in advance according to the type of the graph, for example, to “0.3” in the case of a line graph, or to “0.5” in the case of a bar graph.

The transmittance controller 133 determines whether the second and third transmission processes have been completed for all types of the graphs. If not, the transmittance controller 133 selects the next graph, and performs the second and third transmission processes. If so, the transmittance controller 133 calculates the density, on a divided area-by-divided area basis, based on the coefficient of density set by the third transmission process. The transmittance controller 133 generates the third transmittance that is set to a transmittance according to the maximum density among those in the respective divided areas, with reference to the transmittance storage unit 122. In the example of FIG. 3, if the maximum density is “3”, the transmittance controller 133 generates the third transmittance that is set to a transmittance of 30%.

After completing the generation of the first to third transmittances, the transmittance controller 133 uses Expression (1) below to calculate the final transmittance of each of the graphs, based on the first to third transmittances.

Final transmittance=1−(1−first transmittance)×(1−second transmittance)×(1−third transmittance) (1)

The transmittance controller 133 may obtain the final transmittance corresponding to the type of the graph and the first to third transmittances, based on the first to third transmittances, with reference to the transmittance storage unit 122. The transmittance controller 133 generates output data by setting the calculated or obtained final transmittance for each piece of the graph data, and outputs the output data to the display controller 134. The transmittance controller 133 may leave, for example, the transmittance of the graph in the backmost position in the display order to be unset so as to result in 0%.

The values of the transmittances exemplified in FIGS. 3 to 5 are only examples, and values other than those values may be used as the transmittances. When values other than the values exemplified in FIGS. 3 to 5 are used, the final transmittances are also calculated using Expression (1) given above. If the transmittances of all the graphs are not set, the graphs can be expressed with all the transmittances set to 0%.

Coming back to the description with reference to FIG. 1, after receiving the output data from the transmittance controller 133, the display controller 134 generates the graphs based on the received output data. Specifically, the display controller 134 generates the graphs to be displayed in the graph display area of the display screen, based on the output data. The display controller 134 also generates the layered structure having layers corresponding to the respective generated graphs. The layered structure is a layered structure of the graphs that is displayed in a layered structure display area of the display screen and represents the order of stacking of the graphs in the vertical direction and the width of each of the graphs in the horizontal direction.

The display controller 134 arranges a zone corresponding to each of the graphs in corresponding one of the layers of the layered structure. The zone corresponding to each of the graphs serves as a display corresponding to the graph. The display controller 134 generates the display screen including the generated graphs and the layered structure, and outputs the generated display screen to the display unit 111 to display thereon the display screen.

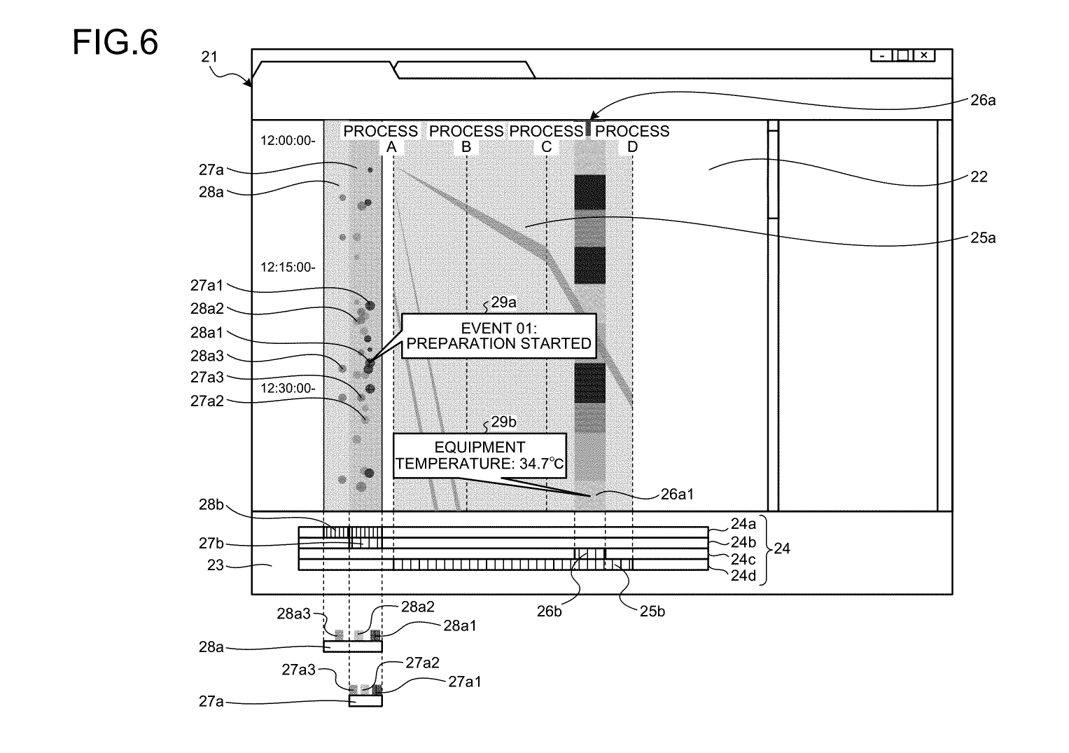

The following describes the display screen including the graph display area and the layered structure display area, using FIG. 6. FIG. 6 is a diagram illustrating an example of the display screen. A display screen 21 illustrated in FIG. 6 includes a graph display area 22 and a layered structure display area 23. The generated graphs are displayed in a superimposed manner in the graph display area 22, and a layered structure 24 is displayed in the layered structure display area 23.

The graph display area 22 displays a plurality of types of graphs in accordance with one time axis. The graph display area 22 displays, for example, a trace graph 25a, a heat map 26a, an event graph 27a, and an event graph 28a in a superimposed manner. The layered structure display area 23 displays the layered structure 24 of the respective graphs that are displayed in a superimposed manner in the graph display area 22. The layered structure 24 indicates that a layer 24a, a layer 24b, a layer 24c, and a layer 24d are stacked from the upper layer downward. In the layered structure 24, the zone corresponding to each of the graphs is arranged in corresponding one of the layers. The zone corresponding to the trace graph 25a is a zone 25b arranged in the layer 24d. The zone corresponding to the heat map 26a is a zone 26b arranged in the layer 24c. The zone corresponding to the event graph 27a is a zone 27b arranged in the layer 24b. The zone corresponding to the event graph 28a is a zone 28b arranged in the layer 24a. In other words, the layered structure 24 in FIG. 6 represents a state in which the graphs are stacked from the trace graph 25a serving as the lowermost layer upward in the order of the heat map 26a, the event graph 27a, and the event graph 28a. The width of each of the zones arranged in the layered structure 24 is the same as the width of corresponding one of the graphs.

On the display screen 21, each of the graphs displayed in the graph display area 22 may be displayed, for example, in the same color as that of a layer of the layered structure 24 corresponding to the graph. For example, on the display screen 21, the trace graph 25a and the zone 25b are displayed in the same color, and the heat map 26a and the zone 26b are displayed in the same color that differs from the color of the trace graph 25a and the zone 25b. To indicate the zone 28b is selected, the zone 28b is displayed, for example, in a color different from those of the other zones, or with the border lines thereof changed to thicker lines. In other words, to indicate the zone 28b is selected, the zone 28b is displayed by performing either or both of the following: changing the color and changing the border lines to thicker lines.

Respective transmittances are set for the trace graph 25a, the heat map 26a, the event graph 27a, and the event graph 28a displayed in a superimposed manner, so that the elements of graphs in the lower layers can be identified. In the example of FIG. 6, the event graph 27a and the event graph 28a are displayed in an overlapping manner. An explanatory diagram schematically representing horizontal positional relations of points in the respective event graphs is illustrated outside the display screen 21. The display unit 111 does not display the explanatory diagram schematically representing the horizontal positional relations of points.

In the event graph 27a, for example, a point 27a1, a point 27a2, and a point 27a3 are arranged at even intervals within the width of the graph. The points 27a1, 27a2, and 27a3 represent different types of events from one another. In the event graph 28a, for example, a point 28a1, a point 28a2, and a point 28a3 are arranged at even intervals within the width of the graph. The points 28a1, 28a2, and 28a3 represent different types of events from one another. In the event graphs 27a and 28a, for example, the points 27a1 and 28a1 represent the same type of event. In the same manner, in the event graphs 27a and 28a, for example, the points 27a2 and 28a2 represent the same type of event, and the points 27a3 and 28a3 represent the same type of event.

On the display screen 21, for example, if a mouseover occurs on an element (object) of each of the graphs, that is, if a mouse cursor overlaps the element, information on the element is displayed using a tooltip. On the display screen 21, for example, occurrence of the mouseover on the point 28a1 displays a tooltip 29a. Also, on the display screen 21, for example, occurrence of the mouseover on a region 26a1 in the band of the heat map 26a displays a tooltip 29b. In this event, the information in the tooltip may be hidden if the tooltip sticks out of the graph display area 22. To avoid this, the display controller 134 causes the tooltip to be displayed at a place moved in a direction that prevents the tooltip from sticking out of the graph display area 22. On the display screen 21, the graph arranged at the top of the layered structure of the graphs serves as the operation target, so that the tooltip displays the information on the object of the graph arranged at the top.

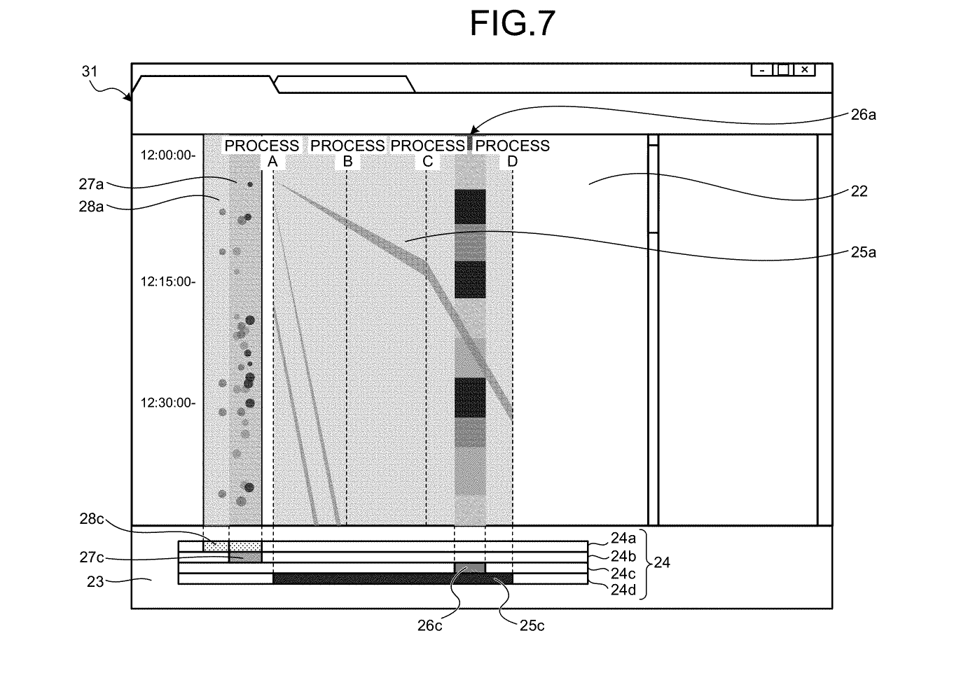

When displaying the layered structure 24, the display controller 134 may display the zones corresponding to the respective graphs so that the brightness decreases as the position of the layer becomes lower, and the brightness increases as the position of the layer becomes higher. FIG. 7 is a diagram illustrating another example of the display screen. A display screen 31 illustrated in FIG. 7 is a screen obtained by modifying the display screen 21 of FIG. 6 by varying the brightness of the zones of the layered structure 24 depending on the layer. On the display screen 31, the brightness is the lowest in a zone 25c corresponding to the trace graph 25a in the lowermost layer, and sequentially increases in the order of a zone 26c corresponding to the heat map 26a, a zone 27c corresponding to the event graph 27a, and a zone 28c corresponding to the event graph 28a. In the example of FIG. 7, the zone 28c is selected, and hence, is displayed, for example, in a color different from those of the other zones, or with the border lines thereof changed to thicker lines.

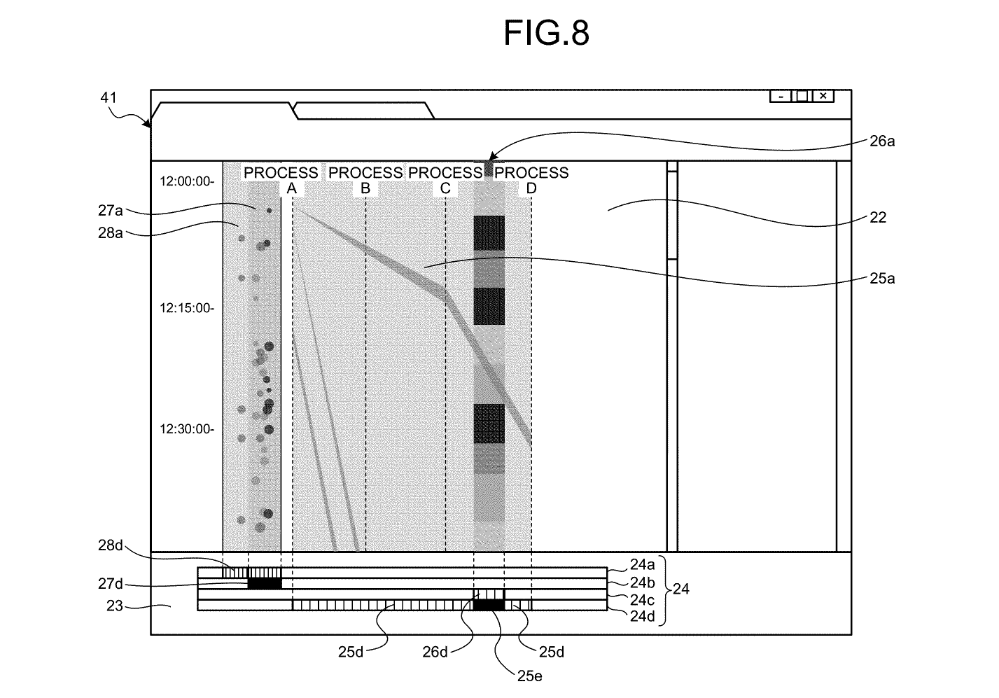

When displaying the layered structure 24, the display controller 134 may place a shadow on a portion of the zone of a lower layer among the zones of the lower layers that is overlapped by the zone of an upper layer, and thus, may express that the shadowed portion is not selectable. FIG. 8 is a diagram illustrating still another example of the display screen. A display screen 41 illustrated in FIG. 8 is a screen obtained by modifying the display screen 21 of FIG. 6 by placing shadows on portions of zones of lower layers overlapped by zones of upper layers, among zones arranged in the layered structure 24. On the display screen 41, for example, a zone 27d corresponding to the event graph 27a is fully overlapped by a zone 28d corresponding to the event graph 28a, so that a shadow indicating the unselectability is placed over the entire zone 27d. Also, on the display screen 41, for example, a zone 25d corresponding to the trace graph 25a is partially overlapped by a zone 26d corresponding to the heat map 26a, so that a shadow 25e is placed on the overlapped portion.

If the layered structure 24 has a large number of layers, the display controller 134 may display the portions of the zones of the lower layers overlapped by the zones of the upper layers as a layered structure, and may display portions of the zones of the lower layers not overlapped by the zones of the upper layers as one layer. In other words, the display controller 134 may display the layered structure by compressing it in the vertical direction.

The following describes the display performed by compressing the layered structure in the vertical direction when the layered structure has a large number of layers. First, the display controller 134 determines whether the number of layers of the layered structure 24 is a predetermined value or smaller, where the predetermined value can be set to, for example, “2”. If so, the display controller 134 displays the layered structure 24 without modification. If not, the display controller 134 determines whether the zone of an upper layer overlaps the zone of a lower layer. If not, the display controller 134 moves the zone of the upper layer to the lowermost layer. If so, the display controller 134 moves the zone of the upper layer to a lower layer in contact with the overlapped zone of the lower layer.

The display controller 134 determines whether all the zones have been determined as to presence of overlapping. If not, the display controller 134 determines as to presence of overlapping among the remaining zones. If so, the display controller 134 generates a layered structure reflecting the movement of the zones. If the zone of an upper layer does not overlap any zone down to a lower layer, and hence, have been moved to the lower layer, the layered structure reflecting the movement of the zone has a smaller number of layers than that of the original layered structure 24.

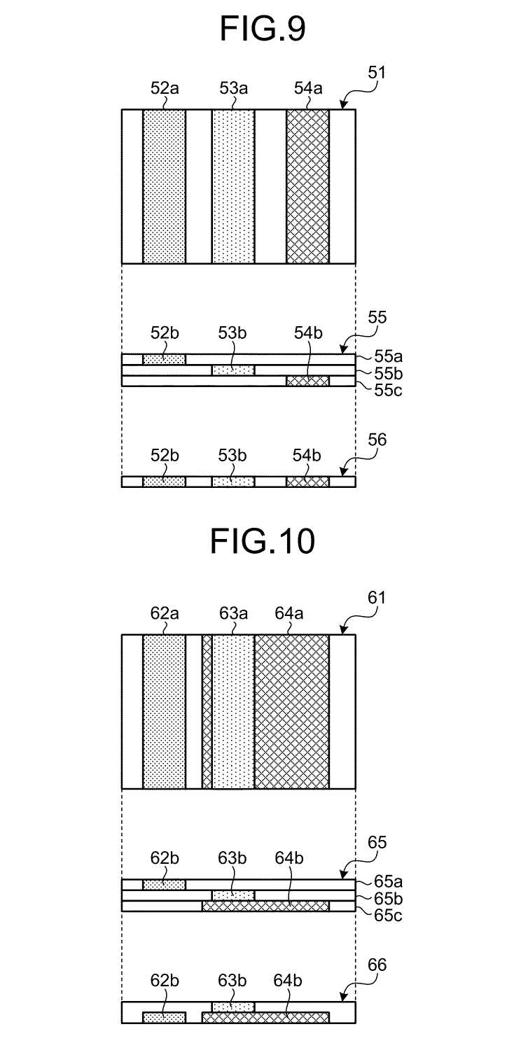

The movement of the zones will be described using FIG. 9 to 11. FIG. 9 is a diagram illustrating an example schematically representing the graphs and the layered structure of the graphs. To simplify the description, the following describes the vertical compression of the layered structure when the number of layers of the layered structure is three, with reference to FIGS. 9 to 11. A graph display area 51 illustrated in FIG. 9 displays graphs 52a, 53a, and 54a. A layered structure 55 of the graphs includes layers 55a, 55b, and 55c from the upper layer downward. A zone 52b corresponding to the graph 52a is arranged in the layer 55a. A zone 53b corresponding to the graph 53a is arranged in the layer 55b. A zone 54b corresponding to the graph 54a is arranged in the layer 55c.

In the example of FIG. 9, the display controller 134 determines whether the zone of each upper layer overlaps the zone of a lower layer. The zones 52b, 53b, and 54b do not overlap one another, so that the display controller 134 moves the zones 52b and 53b to the layer 55c. The display controller 134 generates a layered structure 56 reflecting the movement of the zones 52b, 53b, and 54b.

The following describes the movement of the zones when graphs overlap one another, using FIG. 10. FIG. 10 is a diagram illustrating another example schematically representing the graphs and the layered structure of the graphs. A graph display area 61 illustrated in FIG. 10 displays graphs 62a, 63a, and 64a. A layered structure 65 of the graphs includes layers 65a, 65b, and 65c from the upper layer downward. A zone 62b corresponding to the graph 62a is arranged in the layer 65a. A zone 63b corresponding to the graph 63a is arranged in the layer 65b. A zone 64b corresponding to the graph 64a is arranged in the layer 65c.

In the example of FIG. 10, the display controller 134 determines whether the zone of each upper layer overlaps the zone of a lower layer. According to the result of the determination, the zone 62b overlaps neither of the zones 63b and 64b, but the zone 63b overlaps the zone 64b. The display controller 134 moves the zone 62b to the layer 65c. In the example of FIG. 10, the display controller 134 does not move the zone 63b because the zone 63b is already arranged in the layer 65b. However, if an empty layer or layers lies or lie between the zone 63b and the zone 64b, the display controller 134 moves the zone 63b to a layer in contact with the zone 64b. The display controller 134 generates a layered structure 66 reflecting the movement of the zones 62b, 63b, and 64b. In the layered structure 66, for example, borders between layers can be omitted so as to make it clear that the layered structure has been compressed in the vertical direction, as illustrated in FIG. 10.

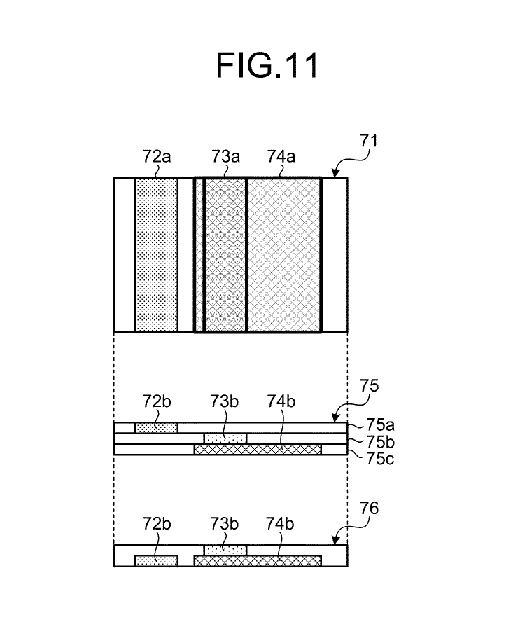

The following describes the movement of the zones and the transmittance of each of the graphs when graphs overlap one another, using FIG. 11. FIG. 11 is a diagram illustrating still another example schematically representing the graphs and the layered structure of the graphs. A graph display area 71 illustrated in FIG. 11 displays graphs 72a, 73a, and 74a. A layered structure 75 of the graphs includes layers 75a, 75b, and 75c from the upper layer downward. A zone 72b corresponding to the graph 72a is arranged in the layer 75a. A zone 73b corresponding to the graph 73a is arranged in the layer 75b. A zone 74b corresponding to the graph 74a is arranged in the layer 75c.

The transmittance controller 133 set the transmittance for each of the graphs 72a, 73a, and 74a. In the example of FIG. 11, the display controller 134 determines whether the zone of each upper layer overlaps the zone of a lower layer. According to the result of the determination, the zone 72b overlaps neither of the zones 73b and 74b, but the zone 73b overlaps the zone 74b. The display controller 134 displays the borders of the graphs 73a and 74a corresponding to the zones 73b and 74b with thicker lines. The display controller 134 may display the border of the graph 73a and the zone 73b in a first color (the same color), and display the border of the graph 74a and the zone 74b in a second color (the same color).

The display controller 134 moves the zone 72b to the layer 75c. In the example of FIG. 11, the display controller 134 does not move the zone 73b because the zone 73b is already arranged in the layer 75b. However, if an empty layer or layers lies or lie between the zone 73b and the zone 74b, the display controller 134 moves the zone 73b to a layer in contact with the zone 74b. The display controller 134 generates a layered structure 76 reflecting the movement of the zones 72b, 73b, and 74b. In the layered structure 76, for example, the border between the layers can be omitted so as to make it clear that the layered structure has been compressed in the vertical direction, as illustrated in FIG. 11.

The display controller 134 does not apply the transmittances set for the graphs 72a, 73a, and 74a to the zones 72b, 73b, and 74b arranged in the layered structure 76. In this manner, the display control device 100 can express the order of superimposition of the graphs in an easily viewable manner by displaying the borders of the graphs with thicker lines, and by not changing the transmittances in the layered structure 76 even if the graphs increase in transmittance. The display controller 134 may set the zones 72b, 73b, and 74b to have the same transmittances as those of the graphs 72a, 73a, and 74a, and display the borders of the zones 72b, 73b, and 74b with thicker lines.

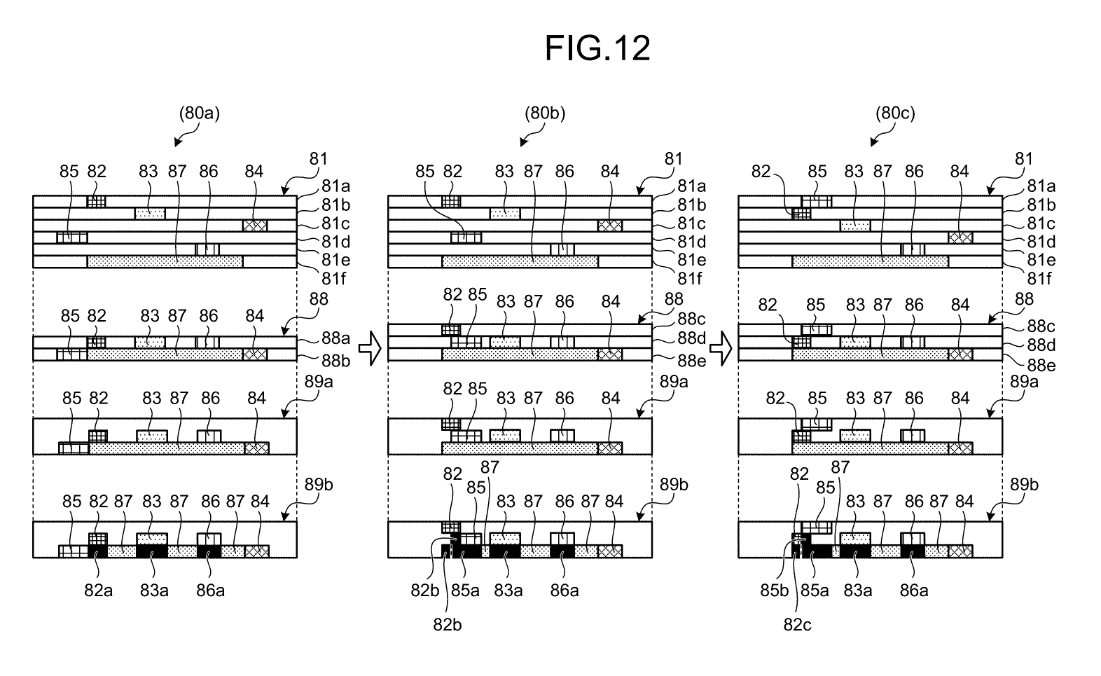

The following describes a case of moving the graphs between layers by moving the zones of the layered structure, with reference to FIG. 12. FIG. 12 is a diagram illustrating an example of movement of the graphs between layers. As illustrated in a state 80a of FIG. 12, a layered structure 81 includes layers 81a, 81b, 81c, 81d, 81e, and 81f from the upper layer downward. In the layered structure 81, a zone 82 is arranged in the layer 81a; a zone 83 is arranged in the layer 81b; and a zone 84 is arranged in the layer 81c. Also, in the layered structure 81, a zone 85 is arranged in the layer 81d; a zone 86 is arranged in the layer 81e; and a zone 87 is arranged in the layer 81f.

A layered structure 88 in the state 80a is a layered structure obtained by modifying the layered structure 81 by moving the zones when graphs overlap one another. The layered structure 88 includes layers 88a and 88b. In the layered structure 88, the zones 82, 83, and 86 are arranged in the layer 88a, and the zones 84, 85, and 87 are arranged in the layer 88b. The layered structure 89a in the state 80a is a layered structure obtained by omitting the borders between layers of the layered structure 88. The layered structure 89b is a layered structure obtained by modifying the layered structure 89a by placing shadows on portions of a zone of a lower layer that are overlapped by zones of an upper layer, among the zones of the lower layer. In the layered structure 89b, a shadow 82a corresponding to the zone 82, a shadow 83a corresponding to the zone 83, and a shadow 86a corresponding to the zone 86 are placed on the zone 87.

States 80a to 80c indicate respective steps of moving the zone 85 from the layer 81d to the layer 81a. The state 80a represents a state before the zone 85 moves. The state 80b represents a state in which the zone 85 has first moved in the horizontal direction to overlap the zone 82. In the layered structure 88 in the state 80b, the zones 82, 85, and 87 overlap one another, so that one layer is added to the layered structure 88, which now has layers 88c, 88d, and 88e from the upper layer downward. In the layered structure 88, the zone 82 is arranged in the layer 88c; the zones 83, 85, and 86 are arranged in the layer 88d; and the zones 84 and 87 are arranged in the layer 88e. In other words, the layered structure 88 indicates that the zone 85 is inserted between the zone 82 and the zone 87. In the state 80b, the layered structure 89a indicates a state in which borders between layers of the layered structure 88 are omitted, and the layered structure 89b indicates a state in which shadows are placed in addition. In the layered structure 89b in the state 80b, a shadows 82b corresponding to the zone 82 is placed on the zones 85 and 87. Also, in the layered structure 89b, a shadow 85a corresponding to the zone 85, the shadow 83a corresponding to the zone 83, and the shadow 86a corresponding to the zone 86 are placed on the zone 87.

The state 80c represents a state obtained by changing the state 80b as follows: the zone 85 further moves in the vertical direction; the zone 82 moves down by one layer to the layer 81b; and thus, the zone 85 moves to the layer 81a that is the uppermost layer. In the layered structure 88 in the state 80c, the zone 85 is arranged in the layer 88c; the zones 82, 83, 86 are arranged in the layer 88d; and the zones 84 and 87 are arranged in the layer 88e. In the state 80c, the layered structure 89a indicates a state in which borders between layers of the layered structure 88 are omitted, and the layered structure 89b indicates a state in which shadows are placed in addition. In the layered structure 89b in the state 80c, a shadow 85b corresponding to the zone 85 is placed on the zone 82. Also, in the layered structure 89b, a shadow 82c corresponding to the zone 82, the shadow 85a corresponding to the zone 85, the shadow 83a corresponding to the zone 83, and the shadow 86a corresponding to the zone 86 are placed on the zone 87. While the state 80c indicates the case in which the shadow 85a is displayed on a portion where the shadow 82c overlaps the shadow 85a, the shadow 82c may be displayed at the overlapping portion. In this manner, the display control device 100 can easily move the graphs between the layers while compressing the display area of the layered structure.

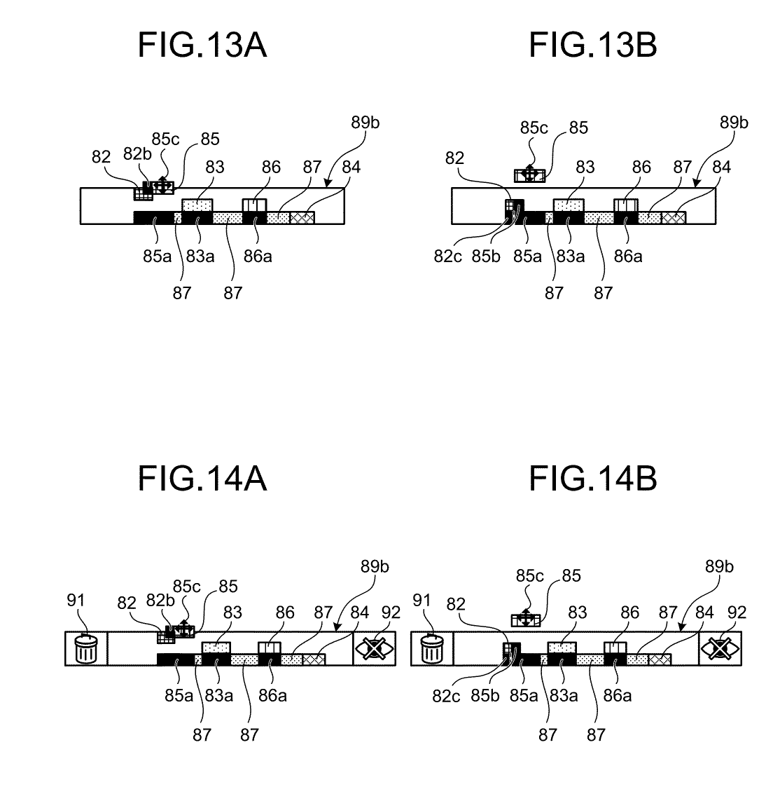

The following describes a method for the movement of the graphs between layers, using FIGS. 13A and 13B. FIGS. 13A and 13B are diagrams illustrating the method for the movement of the graphs between layers. FIG. 13A illustrates a state obtained by changing the state of the layered structure 89b in the state 80b illustrated in FIG. 12 as follows: the zone 85 is dragged upward within the range of the layered structure 89b, that is, within the range in which the zone 85 is in contact with the frame of the layered structure 89b. An icon 85c indicates the state that the zone 85 is being dragged. In FIG. 13A, the zones 82, 83, 84, 86, and 87 and the shadows 83a, 85a, and 86a are arranged in the same manner as in the layered structure 89b in the state 80b illustrated in FIG. 12. The shadow 82b is placed on the zone 85 being dragged. In FIG. 13A, the zone 85 is being dragged upward within the range of the layered structure 89b, so that the zone 85 gradually moves from the layer 81d toward the upper layer on a layer-by-layer basis. Specifically, in FIG. 13A, the zone 85 gradually moves from the layer 81d to the layer 81c, then to the layer 81b, and then to the layer 81a, so that the movement takes time, and the zone 82 arranged in the layer 81a does not move to the layer 81b soon. If the drag is canceled while the zone 85 is gradually moving toward the upper layer, the zone 85 is arranged in a layer where it is at the time of the cancel. If the zone 85 is dragged downward within the range of the layered structure 89b, the zone 85 gradually moves toward the lower layer on a layer-by-layer basis.

FIG. 13B illustrates a state obtained by changing the state of the layered structure 89b in the state 80b illustrated in FIG. 12 as follows: the zone 85 is dragged upward to the outside of the range of the layered structure 89b. In FIG. 13B, the zones 82, 83, 84, 86, and 87 and the shadows 82c, 83a, 85a, 85b, and 86a are arranged in the same manner as in the layered structure 89b in the state 80c illustrated in FIG. 12. In FIG. 13B, the zone 85 is being dragged upward to the outside of the range of the layered structure 89b, so that the zone 85 moves from the layer 81d to the layer 81a that is the uppermost layer. Specifically, in FIG. 13B, the zone 85 moves to the layer 81a, and the zone 82 arranged in the layer 81a moves to the layer 81b. If the zone 85 is dragged downward to the outside of the layered structure 89b, the zone 85 moves to the layer 81f that is the lowermost layer, and each of the other zones moves up by one layer.

Moreover, the following describes methods for deleting and hiding a graph using the layered structure, using FIGS. 14A and 14B. FIGS. 14A and 14B are diagrams illustrating the methods for deleting and hiding a graph using the layered structure. In the layered structure 89b in each of FIGS. 14A and 14B, an icon 91 indicating deletion is arranged on the left side, and an icon 92 indicating hiding is arranged on the right side. The layered structure 89b in FIG. 14A indicates a state in which the zone 85 is dragged upward within the range of the layered structure 89b. In this case, dragging and dropping the zone 85 onto the icon 91 deletes a layer corresponding to the zone 85. Dragging and dropping the zone 85 onto the icon 92 hides the layer corresponding to the zone 85.

The layered structure 89b in FIG. 14B indicates a state in which the zone 85 is dragged upward outside the range of the layered structure 89b. In this case, dragging and dropping the zone 85 onto the icon 91 deletes the layer corresponding to the zone 85. Dragging and dropping the zone 85 onto the icon 92 hides the layer corresponding to the zone 85. The deletion operation differs from the hiding operation in that the deletion operation deletes the settings for the timeline of a graph, so that a procedure needs to be started from registration of data in order to display the graph again. In contrast, the hiding operation does not delete the settings for the timeline of the graph, so that the graph is displayed again by switching the setting between displaying and hiding. In other words, the hiding operation keeps the settings for the layer of the graph. In this manner, the display control device 100 can improve the ease of operation to the graph.

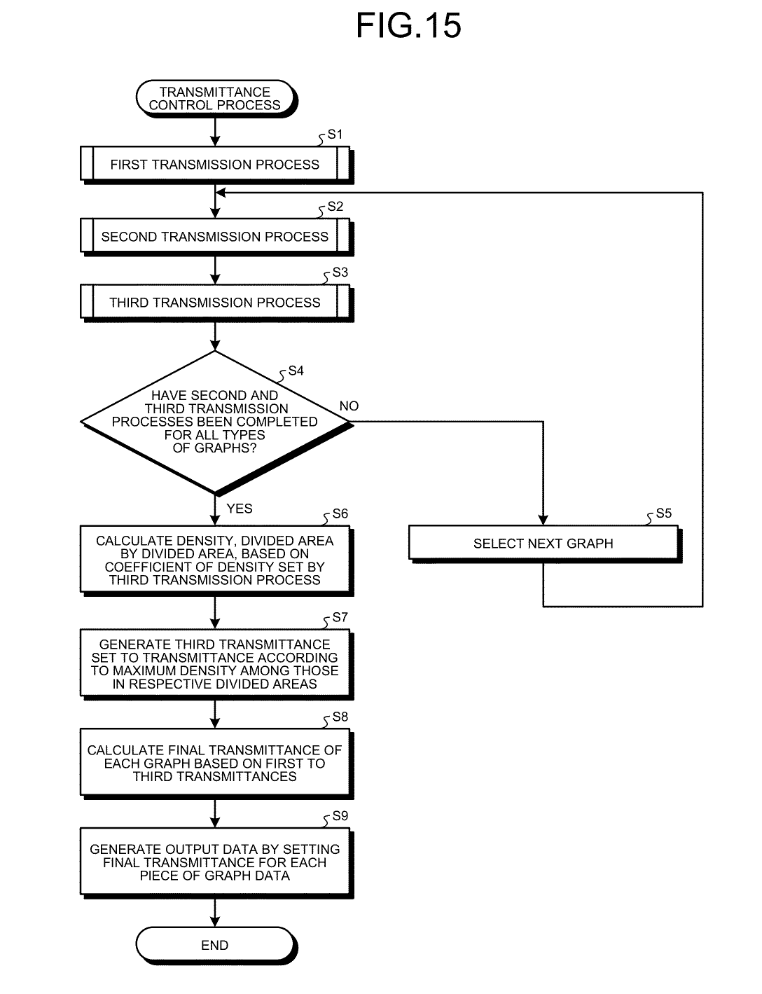

The following describes operations of the display control system 1 of the embodiment. A transmittance control process will be described first. FIG. 15 is a flowchart illustrating an example of the transmittance control process of the embodiment. After receiving the operational information to display the graphs from the operation unit 112, the acceptance unit 131 of the display control device 100 accepts to display the graphs. After accepting to display the graphs, the acceptance unit 131 acquires the log data from the various devices via the communication unit 110. The acceptance unit 131 stores the acquired log data in the log storage unit 121. After completing to store the acquired log data, the acceptance unit 131 outputs the generation information to the generation unit 132. After receiving the generation information from the acceptance unit 131, the generation unit 132 performs the first transmission process (Step S1).

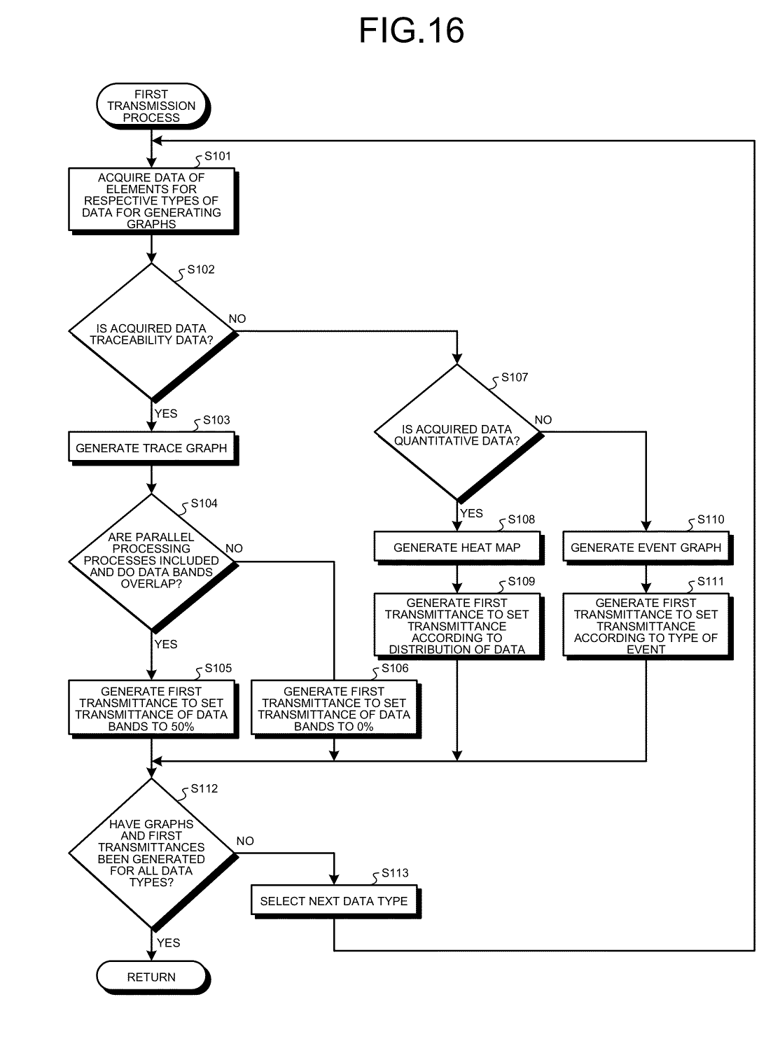

The first transmission process will be described using FIG. 16. FIG. 16 is a flowchart illustrating an example of the first transmission process. The generation unit 132 acquires data of the respective elements for the respective types of the data for generating the graphs, from the log storage unit 121 (Step S101). The generation unit 132 determines whether the acquired data is the traceability data (Step S102). If so (Yes at Step S102), the generation unit 132 generates the trace graph in which the start times of the respective processes are interconnected, the end times of the respective processes are interconnected, and the results are expressed as the data bands (Step S103). The generation unit 132 outputs the generated trace graph as the graph data to the transmittance controller 133.

After the trace graph is received as the graph data from the generation unit 132, the transmittance controller 133 determines whether the trace graph includes parallel processing processes and also the data bands overlap one another (Step S104). If so (Yes at Step S104), the transmittance controller 133 generates the first transmittance to set the transmittance of the data bands to 50% (Step S105). If not (No at Step S104), the transmittance controller 133 generates the first transmittance to set the transmittance of the data bands to 0% (Step S106).

Coming back to the description of Step S102, if the acquired data is not the traceability data (No at Step S102), the generation unit 132 determines whether the acquired data is the quantitative data (Step S107). If so (Yes at Step S107), the generation unit 132 generates the heat map (Step S108). The generation unit 132 outputs the generated heat map as the graph data to the transmittance controller 133. After receiving the heat map as the graph data from the generation unit 132, the transmittance controller 133 generates the first transmittance that is set to a transmittance according to the distribution of the data (Step S109).

If the acquired data is not the quantitative data (No at Step S107), the generation unit 132 determines that the acquired data is the event data, and generates an event graph (Step S110). The generation unit 132 outputs the generated event graph as the graph data to the transmittance controller 133. After receiving the event graph as the graph data from the generation unit 132, the transmittance controller 133 generates the first transmittance that is set to a transmittance according to the type of the event (Step S111).

The transmittance controller 133 determines whether the generation of the graphs and the first transmittances has been completed for all the data types (Step S112). If not (No at Step S112), the transmittance controller 133 selects the next data type (Step S113), and outputs a command for generating a graph to the generation unit 132. Then, the process returns to Step S101. If the generation of the graphs and the first transmittances has been completed for all the data types (Yes at Step S112), the process returns to the main procedure of the transmittance control process. In this manner, the display control device 100 can generate the first transmittance.

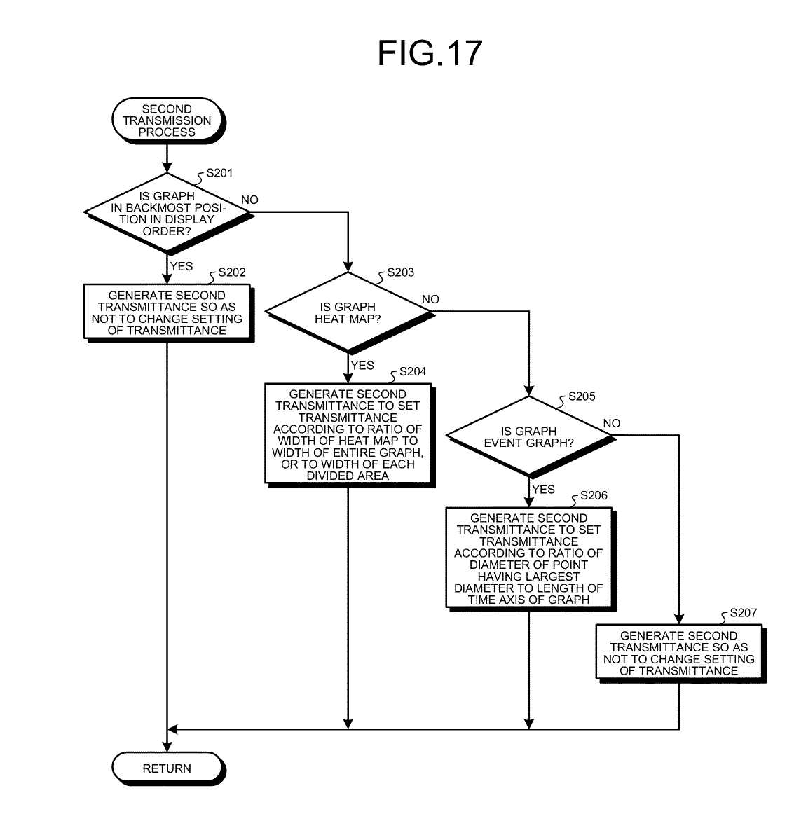

Coming back to the description with reference to FIG. 15, the transmittance controller 133 performs the second transmission process (Step S2). The second transmission process will be described using FIG. 17. FIG. 17 is a flowchart illustrating an example of the second transmission process. The transmittance controller 133 determines whether the graph for which the first transmittance has been generated is in the backmost position in the display order (Step S201). If so (Yes at Step S201), the transmittance controller 133 generates the second transmittance so as not to change the setting of the transmittance (Step S202), and the process returns to the main procedure of the transmittance control process.

If not (No at Step S201), the transmittance controller 133 determines whether the graph is a heat map (Step S203). If so (Yes at Step S203), the transmittance controller 133 generates the second transmittance that is set to a transmittance according to the ratio of the width of the heat map to the width of the entire graph, or to the width of each of the divided areas (Step S204).

If not (No at Step S203), the transmittance controller 133 determines whether the graph is an event graph (Step S205). If so (Yes at Step S205), the transmittance controller 133 generates the second transmittance that is set to a transmittance according to the ratio of the diameter of a point having the largest diameter to the length of the time axis of the graph (Step S206), and the process returns to the main procedure of the transmittance control process. If not (No at Step S205), the transmittance controller 133 generates the second transmittance so as not to change the setting of the transmittance (Step S207), and the process returns to the main procedure of the transmittance control process. In this manner, the display control device 100 can generate the second transmittance.

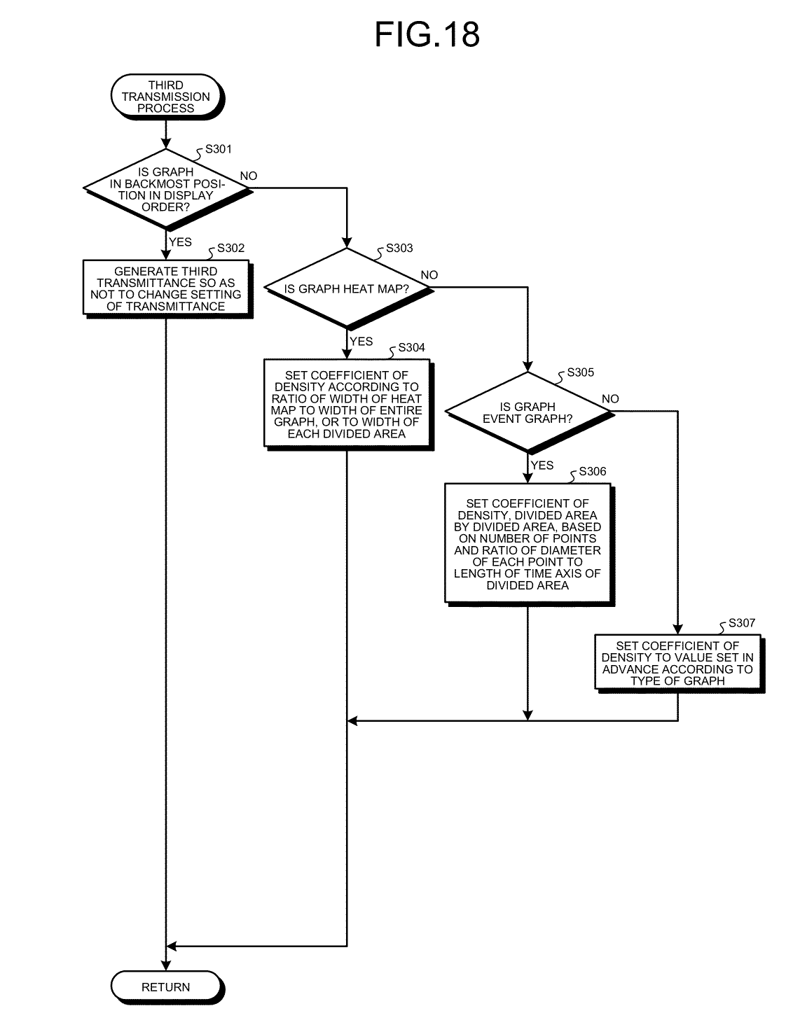

Coming back to the description with reference to FIG. 15, the transmittance controller 133 performs the third transmission process (Step S3). The third transmission process will be described using FIG. 18. FIG. 18 is a flowchart illustrating an example of the third transmission process. The transmittance controller 133 determines whether the graph for which the second transmittance has been generated is in the backmost position in the display order (Step S301). If so (Yes at Step S301), the transmittance controller 133 generates the third transmittance so as not to change the setting of the transmittance (Step S302), and the process returns to the main procedure of the transmittance control process.

If not (No at Step S301), the transmittance controller 133 determines whether the graph is a heat map (Step S303). If so (Yes at Step S303), the transmittance controller 133 sets the coefficient of density according to the ratio of the width of the heat map to the width of the entire graph, or to the width of each of the divided areas (Step S304), and the process returns to the main procedure of the transmittance control process.

If not (No at Step S303), the transmittance controller 133 determines whether the graph is an event graph (Step S305). If so (Yes at Step S305), the transmittance controller 133 sets the coefficient of density on a divided area-by-divided area basis, based on the number of points in the event graph and the ratio of the diameter of each of the points to the length of the time axis of the divided area (Step S306), and the process returns to the main procedure of the transmittance control process. If not (No at Step S305), the transmittance controller 133 sets the coefficient of density to a value set in advance according to the type of the graph (Step S307), and the process returns to the main procedure of the transmittance control process. In this manner, the display control device 100 can set the coefficient of density used for generating the third transmittance.

Coming back to the description with reference to FIG. 15, the transmittance controller 133 determines whether the second and third transmission processes have been completed for all types of the graphs (Step S4). If not (No at Step S4), the transmittance controller 133 selects the next graph (Step S5), and repeats the process from Step S2. If so (Yes at Step S4), the transmittance controller 133 calculates the density, on a divided area-by-divided area basis, based on the coefficient of density set by the third transmission process (Step S6).

The transmittance controller 133 generates the third transmittance that is set to a transmittance according to the maximum density among those in the respective divided areas (Step S7). After completing the generation of the first to third transmittances, the transmittance controller 133 calculates the final transmittance of each of the graphs, based on the first to third transmittances (Step S8). The transmittance controller 133 generates output data by setting the calculated final transmittance for each piece of the graph data, and outputs the output data to the display controller 134 (Step S9). In this manner, the display control device 100 can generate the output data for visibly displaying a plurality of types of the superimposed objects.

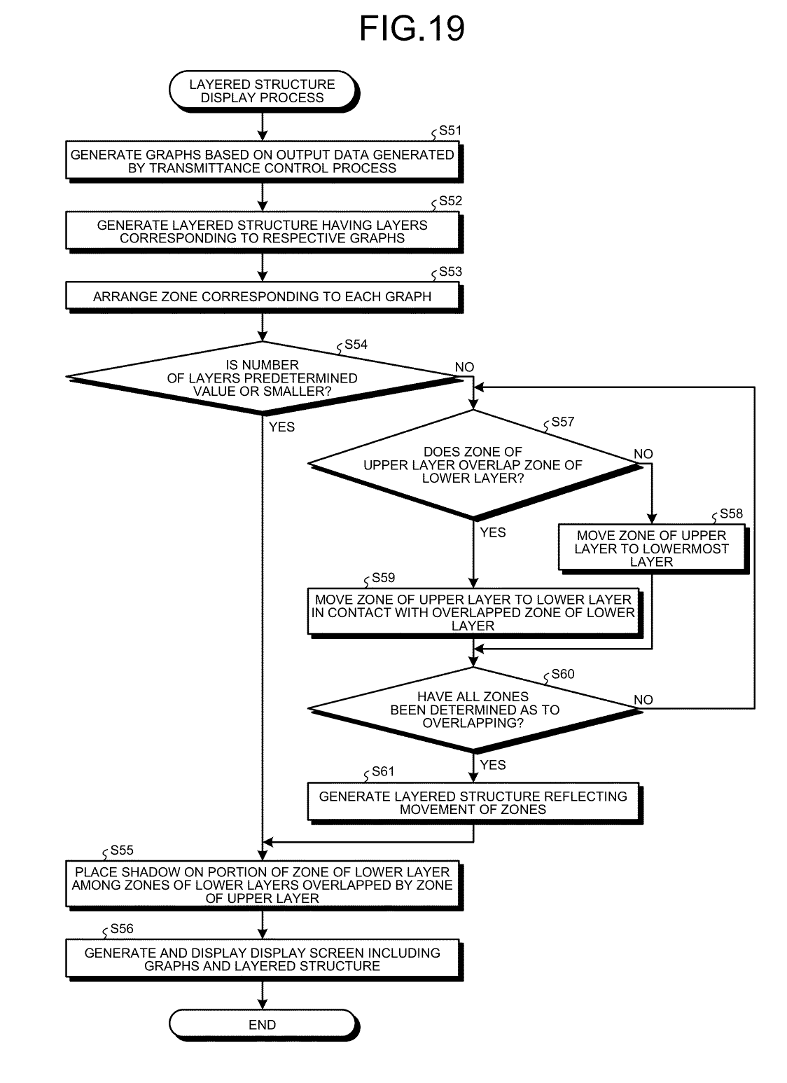

The following describes a layered structure display process. FIG. 19 is a flowchart illustrating an example of the layered structure display process of the embodiment. After receiving the output data from the transmittance controller 133, the display controller 134 generates the graphs based on the received output data (Step S51). The display controller 134 of the display control device 100 generates the layered structure having the layers corresponding to the respective generated graphs (Step S52). The display controller 134 arranges the zone corresponding to each of the graphs in corresponding one of the layers of the layered structure (Step S53). The display controller 134 determines whether the number of layers of the layered structure is the predetermined value or smaller (Step S54).

If so (Yes at Step S54), the display controller 134 places a shadow on a portion of the zone of a lower layer among the zones of the lower layers that is overlapped by the zone of an upper layer (Step S55). The display controller 134 generates the display screen including the graphs and the layered structure, and outputs the generated display screen to the display unit 111 to display thereon the display screen (Step S56).

If the number of layers of the layered structure is not the predetermined value or smaller (No at Step S54), the display controller 134 determines whether the zone of each upper layer overlaps the zone of a lower layer (Step S57). If not (No at Step S57), the display controller 134 moves the zone of the upper layer to the lowermost layer (Step S58). If so (Yes at Step S57), the display controller 134 moves the zone of the upper layer to a lower layer in contact with the overlapped zone of the lower layer (Step S59).

The display controller 134 determines whether all the zones have been determined as to presence of overlapping (Step S60). If not (No at Step S60), the display controller 134 repeats the process from Step S57. If so (Yes at Step S60), the display controller 134 generates the layered structure reflecting the movement of the zones (Step S61). After generating the layered structure, the display controller 134 places a shadow on a portion of the zone of a lower layer among the zones of the lower layers that is overlapped by the zone of an upper layer (Step S55). The display controller 134 generates the display screen including the graphs and the layered structure, and outputs the generated display screen to the display unit 111 to display thereon the display screen (Step S56). In this manner, the display control device 100 can perform display that makes it easy to understand which graph object is the operation target. Specifically, the display control device 100 displays the superimposed relations among the graphs (objects) superimposed in the graph display area, and hence, can allow a user to easily visibly identify to which graph an object indicated by a pointer belongs. The display control device 100 displays the layered structure in conjunction with the graphs, so that the operation target object can be easily recognized, and the user can easily recognize the operation target object even when referring to graphs generated by another person.

As described above, the display control system 1 includes at least the display control device 100. When the display control device 100 displays the graphs in a layered manner by performing the translucent display, the display control device 100 displays the layered structure of the graphs that represents the order of stacking of the graphs in the vertical direction and the width of each of the graphs in the horizontal direction. As a result, the display control device 100 can perform display that makes it easy to understand which graph object is the operation target.

The display control device 100 displays the borders of a plurality of graphs with thicker lines. As a result, the graphs can be easily distinguished even if transmittances are set for the respective graphs.

The display control device 100 displays the border of a first graph among the graphs in the first color and the border of a second graph among the graphs in the second color. In displaying the layered structure of the graphs, the display control device 100 uses the first color for the display corresponding to the first graph, and uses the second color for the display corresponding to the second graph. As a result, the user can easily distinguish the correspondence of each of the graphs to the display corresponding to the graph.

In displaying the layered structure of the graphs, the display control device 100 sets the horizontal width of the display corresponding to each of the graphs to the same width as the width of the corresponding graph. As a result, the user can easily distinguish the correspondence of each of the graphs to the display corresponding to the graph.

In displaying the layered structure of the graphs, when a display corresponding to a graph is moved in the display area of the layered structure of the graphs, the display control device 100 moves the display corresponding to the moved graph on a layer-by-layer basis, and displays the moved display. When the display corresponding to the graph is moved out of the display area of the layered structure of the graphs, the display control device 100 moves the display corresponding to the moved graph to the uppermost layer or the lowermost layer depending on the moving direction, and displays the moved display. As a result, even if the layered structure has a large number of layers, the display corresponding to the graph can be easily moved to a layer according to the purpose of the movement.

In displaying the layered structure of the graphs, if a display corresponding to a graph in an upper layer does not overlap a display corresponding to a graph in a lower layer, the display control device 100 moves the display corresponding to the graph in the upper layer to the lower layer, and displays the moved display. If the display corresponding to the graph in the upper layer overlaps the display corresponding to the graph in the lower layer, the display control device 100 moves the display corresponding to the graph in the upper layer to a lower layer in contact with the overlapped display corresponding to the graph in the lower layer, and displays the moved display. As a result, the layered structure can be displayed with a compressed vertical length.

If the display corresponding to the graph in the upper layer overlaps the display corresponding to the graph in the lower layer, the display control device 100 displays a portion of the display corresponding to the graph in the lower layer overlapped by the display corresponding to the graph in the upper layer, as a shadow. As a result, the portion placed on the backside of the graph on the front side can be easily distinguished.

In displaying the layered structure of the graphs, the display control device 100 displays the display corresponding to the graph at lower brightness as the layer becomes lower, and at higher brightness as the layer becomes higher. As a result, the user can easily understand the layered structure of the graphs.

In displaying the layered structure of the graphs, the display control device 100 displays the display corresponding to a selected one of the graphs by performing either or both of changing the color and changing the border lines to thicker lines. As a result, the user can easily distinguish the display corresponding to the selected graph.

In displaying the layered structure of the graphs, the display control device 100 displays the display corresponding to the graph at the same transmittance as a transmittance of the corresponding graph. As a result, the user can easily distinguish the display corresponding to the graph.

In the embodiment described above, the case has been described in which no change is made in the arrangement positions of the contents of the first display component or the second display component, that is, the data of the respective graphs. However, the present invention is not limited to this case. For example, if the time axis of the graphs is changed, the arrangement positions of the data of the respective graphs may be changed in accordance with the time axis, and the transmittance of the first display component or the second display component may be controlled according to the density of the contents of the first display component or the second display component after the change. In other words, if the time axis of the graphs is changed, the display control device 100 changes the arrangement of the data of the respective graphs in accordance with the time axis, so that the density of data (elements) in the predetermined areas changes. Hence, the display control device 100 controls the transmittance of each of the graphs according to the change in the density. In other words, if the time axis of the graphs is expanded, the display control device 100 changes the size of the divided area, so that the density of data in the divided area decreases, and important data decreases in transmittance to be more easily visible. In this manner, the display control device 100 can visibly display the superimposed objects even after the time axis of the graphs is changed.

In the embodiment described above, the display control device 100 displays the graph display area in the upper part of the display screen and the layered structure in the lower part of the display screen. However, the present invention is not limited to this example. For example, the layered structure may be displayed in the upper part of the display screen, and the graph display area may be displayed in the lower part of the display screen.

In the embodiment described above, the graphs are expressed in gray scale. However, the present invention is not limited to this example. For example, the heat map for representing temperature may display the temperature in colors, such as blue, green, yellow, orange, and red, in the order from low temperature to high temperature. The points displayed in the event graph may be colored in, for example, red, green, and blue, according to the importance.

The components of the units illustrated in FIG. 1 need not be physically configured as illustrated. In other words, specific forms of distribution and integration of the units are not limited to those illustrated in FIG. 1, but some or all of the components can be functionally or physically configured in a distributed or integrated manner in any units according to, for example, various load and use conditions. For example, the transmittance controller 133 may be divided into first, second, and third transmittance controllers.

Moreover, all or any of various processing functions executed by the devices may be executed on a CPU (or a microcomputer, such as an MPU or a microcontroller unit [MCU]). All or any of the various processing functions may naturally be executed by a program analyzed and executed on the CPU (or the microcomputer, such as the MPU or the MCU), or by hardware using wired logic.

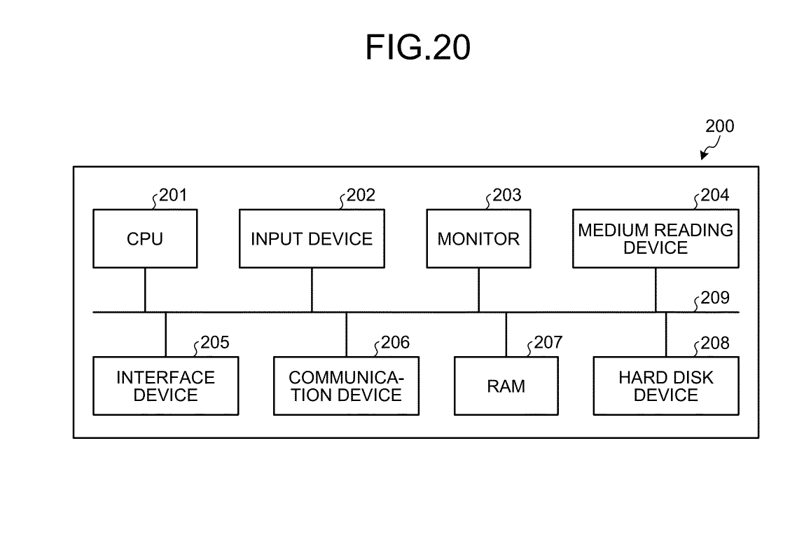

The various processes described in the above embodiment can be performed by executing a prepared program on a computer. The following describes an example of the computer that executes the program having the same functions as those of the embodiment described above. FIG. 20 is a diagram illustrating the example of the computer for executing the graph display program.

As illustrated in FIG. 20, this computer 200 includes a CPU 201 for executing various types of arithmetic processing, an input device 202 for accepting data input, and a monitor 203. The computer 200 also includes a medium reading device 204 for reading programs and the like from a recording medium, an interface device 205 for connecting to the various devices, and a communication device 206 for wiredly or wirelessly connecting to other information processing devices and the like. The computer 200 also includes a RAM 207 for temporarily storing therein various types of information and a hard disk device 208. The devices 201 to 208 are connected to a bus 209.

The hard disk device 208 stores therein the graph display program having the same functions as those of the processing units, that is, the acceptance unit 131, the generation unit 132, the transmittance controller 133, and the display controller 134, illustrated in FIG. 1. The hard disk device 208 implements the log storage unit 121 and the transmittance storage unit 122, and stores therein various types of data for executing the graph display program. The input device 202 accepts, for example, various types of information, such as the operational information and administrative information, from an administrator of the computer 200. The monitor 203 displays, for example, the display screen, a screen for the administrative information, and various screens, for the administrator of the computer 200. The interface device 205 is connected to, for example, a printer. The communication device 206 has, for example, the same function as that of the communication unit 110 illustrated in FIG. 1, is connected to the network (not illustrated), and exchanges various types of information with the various devices.

The CPU 201 executes the various types of processing by reading the programs stored in the hard disk device 208, and loading and executing the programs in the RAM 207. The programs can operate the computer 200 to serve as the acceptance unit 131, the generation unit 132, the transmittance controller 133, and the display controller 134 illustrated in FIG. 1.

The graph display program described above needs not be stored in the hard disk device 208. For example, the computer 200 may read and execute the program stored in a storage medium readable by the computer 200. Examples of the storage medium readable by the computer 200 include, but are not limited to, portable recording media such as CD-ROMs, DVDs, and Universal Serial Bus (USB) memories, semiconductor memories such as flash memories, and hard disk drives. The graph display program may be stored in a device connected to a public line, the Internet, a LAN, or the like, and may be read from the device and executed by the computer 200.

A display can be made that makes it easy to understand which graph object is an operation target.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A display control system comprising:
a display control device including
a memory; and
a processor coupled to the memory, wherein the processor executes a process comprising:
displaying, when displaying a plurality of graphs in a layered manner by performing translucent display, a layered structure of the graphs that represents an order of stacking of the graphs in a vertical direction and a width of each of the graphs in a horizontal direction.

2. The display control system according to claim 1, wherein the displaying displays borders of the graphs with thicker lines.

3. The display control system according to claim 1, wherein the displaying displays a border of a first graph among the graphs in a first color and a border of a second graph among the graphs in a second color, and, in the display of the layered structure of the graphs, uses the first color for the display corresponding to the first graph, and uses the second color for the display corresponding to the second graph.

4. The display control system according to claim 1, wherein, in the display of the layered structure of the graphs, the displaying sets a horizontal width of the display corresponding to each of the graphs to the same width as a width of the corresponding graph.

5. The display control system according to claim 1, wherein, in the display of the layered structure of the graphs, when the display corresponding to the graph is moved in a display area of the layered structure of the graphs, the displaying moves the display corresponding to the moved graph on a layer-by-layer basis, and displays the moved display, and, when the display corresponding to the graph is moved out of the display area of the layered structure of the graphs, the displaying moves the display corresponding to the moved graph to the uppermost layer or the lowermost layer depending on a moving direction, and displays the moved display.

6. The display control system according to claim 1, wherein, in the display of the layered structure of the graphs, in a case where the display corresponding to a graph in an upper layer does not overlap the display corresponding to a graph in a lower layer, the displaying moves the display corresponding to the graph in the upper layer to the lower layer, and, in a case where the display corresponding to the graph in the upper layer overlaps the display corresponding to the graph in the lower layer, the displaying moves the display corresponding to the graph in the upper layer to a lower layer in contact with the overlapped display corresponding to the graph in the lower layer, and displays the moved display.

7. The display control system according to claim 6, wherein, in a case where the display corresponding to the graph in the upper layer overlaps the display corresponding to the graph in the lower layer, the displaying displays a portion of the display corresponding to the graph in the lower layer overlapped by the display corresponding to the graph in the upper layer, as a shadow.

8. The display control system according to claim 1, wherein, in the display of the layered structure of the graphs, the displaying displays the display corresponding to the graph at lower brightness as the layer becomes lower, and at higher brightness as the layer becomes higher.

9. The display control system according to claim 1, wherein, in the display of the layered structure of the graphs, the displaying displays the display corresponding to a selected one of the graphs by performing either or both of changing colors and changing borders to thicker lines.

10. The display control system according to claim 1, wherein, in the display of the layered structure of the graphs, the displaying displays the display corresponding to the graph at the same transmittance as a transmittance of the corresponding graph.

11. A graph display method executed by a computer, comprising:
acquiring, a log data from devices, using a processor; and
displaying, based on the acquired log data, when displaying a plurality of graphs in a layered manner by performing translucent display, a layered structure of the graphs that represents an order of stacking of the graphs in a vertical direction and a width of each of the graphs in a horizontal direction, using the processor.

12. The graph display method according to claim 11, wherein the displaying displays borders of the graphs with thicker lines.

13. The graph display method according to claim 11, wherein, the displaying displays a border of a first graph among the graphs in a first color and a border of a second graph among the graphs in a second color, and, in the display of the layered structure of the graphs, uses the first color for the display corresponding to the first graph, and uses the second color for the display corresponding to the second graph.

14. The graph display method according to claim 11, wherein, in the display of the layered structure of the graphs, the displaying sets a horizontal width of the display corresponding to each of the graphs to the same width as a width of the corresponding graph.

15. The graph display method according to claim 11, wherein, in the display of the layered structure of the graphs, when the display corresponding to the graph is moved in a display area of the layered structure of the graphs, the displaying moves the display corresponding to the moved graph on a layer-by-layer basis, and displays the moved display, and, when the display corresponding to the graph is moved out of the display area of the layered structure of the graphs, the displaying moves the display corresponding to the moved graph to the uppermost layer or the lowermost layer depending on a moving direction, and displays the moved display.

16. The graph display method according to claim 11, wherein, in the display of the layered structure of the graphs, in a case where the display corresponding to a graph in an upper layer does not overlap the display corresponding to a graph in a lower layer, the displaying moves the display corresponding to the graph in the upper layer to the lower layer, and, in a case where the display corresponding to the graph in the upper layer overlaps the display corresponding to the graph in the lower layer, the displaying moves the display corresponding to the graph in the upper layer to a lower layer in contact with the overlapped display corresponding to the graph in the lower layer, and displays the moved display.

17. The graph display method according to claim 16, wherein, in a case where the display corresponding to the graph in the upper layer overlaps the display corresponding to the graph in the lower layer, the displaying displays a portion of the display corresponding to the graph in the lower layer overlapped by the display corresponding to the graph in the upper layer, as a shadow.

18. The graph display method according to claim 11, wherein, in the display of the layered structure of the graphs, the displaying displays the display corresponding to the graph at lower brightness as the layer becomes lower, and at higher brightness as the layer becomes higher.

19. The graph display method according to claim 11, wherein, in the display of the layered structure of the graphs, the displaying displays the display corresponding to a selected one of the graphs by performing either or both of changing colors and changing borders to thicker lines.

20. The graph display method according to claim 11, wherein, in the display of the layered structure of the graphs, the displaying displays the display corresponding to the graph at the same transmittance as a transmittance of the corresponding graph.
